(19) United States
(12) Patent Application Publication
(10) Pub. No.: US 2024/0190373 A1
(43) Pub. Date: Jun. 13, 2024

(54) Active Adaptive Interior Surface Mechanism

(71) Applicant: Karma Automotive LLC, Irvine, CA (US)

(72) Inventor: David D. Fontana, Carlsbad, CA (US)

(73) Assignee: Karma Automotive LLC, Irvine, CA (US)

(21) Appl. No.: 18/063,798

(22) Filed: Dec. 9, 2022

(51) Int. Cl. B60R 21/013; B60R 11/02; B60R 21/02

(52) U.S. Cl. CPC B60R 21/013; B60R 11/0235; B60R 21/02; B60R 2021/01211

(57) ABSTRACT

A method includes receiving a collision notification signal indicating that a vehicle has experienced a collision. An airbag is disposed within an interior cabin of the vehicle, is deployable from a non-deployed state to a deployed state, and is configured to occupy an inflation region within the interior cabin in the deployed state. The vehicle includes an interior surface feature movable between first and second positions. The airbag is prevented from occupying the inflation region when the interior surface feature is in the first position. An actuator is coupled to the interior surface feature and configured to move the interior surface feature from the first position to the second position when the airbag deploys. Based on the collision notification signal, the method includes operating the actuator to move the interior surface feature from the first position to the second position to permit the airbag to occupy the inflation region.

### TECHNICAL FIELD

The present disclosure relates to an active adaptive interior surface mechanism.

### BACKGROUND

A vehicle typically includes one or more airbags that are stored behind surfaces in the interior cabin of the vehicle and configured to deploy in response to the vehicle experiencing a collision. When the vehicle experiences a collision, the airbags rapidly inflate and expand from their stored positions with interior surfaces of the vehicle as reaction surfaces to cushion or reduce the force of impact caused by the collision on vehicle occupants. Conventional interior surfaces at and near airbag storage positions typically have a smooth contour or profile to avoid obstruction of the airbags as they deploy and move along the interior surfaces. While airbag deployment guidelines ensure reliable and safe deployment of the airbags, they limit new concepts for interior design and functionality.

### SUMMARY

One aspect of the disclosure provides a computer-implemented method that when executed on data processing hardware causes the data processing hardware to perform operations. The operations include receiving a collision notification signal indicating that a vehicle has experienced a collision. The vehicle includes an airbag disposed within an interior cabin of the vehicle and deployable from a non-deployed state to a deployed state. The airbag is configured to occupy an inflation region within the interior cabin while in the deployed state. The vehicle includes an interior surface feature movable between a first position and a second position. The airbag is prevented from occupying the inflation region when the interior surface feature is in the first position. The vehicle includes an actuator coupled to the interior surface feature and configured to move the interior surface feature from the first position to the second position when the airbag deploys from the non-deployed state to the deployed state. Based on receiving the collision notification signal, the operations include operating the actuator to move the interior surface feature from the first position to the second position to permit the airbag to occupy the inflation region within the interior cabin of the vehicle. This aspect may include one or more of the following optional features.

In some implementations, when the interior surface feature is in the first position, the interior surface feature is in a nominal position that protrudes from a dashboard of the vehicle. When the actuator is moving the interior surface feature from the first position to the second position, the interior surface feature moves toward the dashboard. In further implementations, a surface gap is defined between the interior surface feature and the dashboard of the vehicle when the interior surface feature is in the nominal position that protrudes from the dashboard of the vehicle. A length of the surface gap defined between the interior surface feature and the dashboard decreases as the interior surface feature moves toward the dashboard. In even further implementations, the surface gap prevents the airbag from occupying the inflation region when the interior surface feature is in the nominal position. In other further implementations, when the interior surface feature is in the second position, the interior surface feature is in a retracted position coplanar with the dashboard.

In some examples, the actuator includes a linear actuator configured to actuate between an extended position and a retracted position. In further examples, the linear actuator is in one of the extended position or the retracted position when the interior surface feature is in the first position and is in the other one of the extended position or the retracted position when the interior surface feature is in the second position. In other further examples, operating the actuator to move the interior surface feature from the first position to the second position includes operating the linear actuator to actuate from one of the extended position or the retracted position to the other one of the extended position or the retracted position.

The interior surface feature may include a display screen of the vehicle. Optionally, the actuator is further operable to adjust an angle of the display screen relative to a dashboard of the vehicle.

In some implementations, when the interior surface feature is in the first position, the interior surface feature is in a nominal position retracted toward a dashboard of the vehicle. When the actuator is moving the interior surface feature from the first position to the second position, the interior surface feature moves away from the dashboard. In further implementations, a cavity is defined between the interior surface feature and an interior floor of the vehicle when the interior surface feature is in the nominal position. The cavity prevents the airbag from occupying the inflation region when the interior surface feature is in the nominal position. A volume of the cavity defined between the interior surface feature and the interior floor of the vehicle reduces as the interior surface feature moves away from the dashboard. Optionally, the interior surface feature includes a knee bolster panel.

Another aspect of the disclosure provides a vehicle. The vehicle includes an airbag disposed within an interior cabin of the vehicle. The airbag is deployable from a non-deployed state to a deployed state. The airbag is configured to occupy an inflation region within the interior cabin of the vehicle while in the deployed state. The vehicle includes an interior surface feature movable between a first position and a second position. The airbag is prevented from occupying the inflation region when the interior surface feature is in the first position. The vehicle includes an actuator coupled to the interior surface feature and configured to move the interior surface feature from the first position to the second position when the airbag deploys from the non-deployed state to the deployed state. The vehicle includes a controller executing instructions that cause the controller to perform operations. The operations include receiving a collision notification signal indicating that the vehicle has experienced a collision. Based on receiving the collision notification signal, the operations include operating the actuator to move the interior surface feature from the first position to the second position to permit the airbag to occupy the inflation region within the interior cabin of the vehicle. This aspect may include one or more of the following optional features.

In some implementations, when the interior surface feature is in the first position, the interior surface feature is in a nominal position that protrudes from a dashboard of the vehicle. When the actuator is moving the interior surface feature from the first position to the second position, the interior surface feature moves toward the dashboard. In further implementations, a surface gap is defined between the interior surface feature and the dashboard of the vehicle when the interior surface feature is in the nominal position that protrudes from the dashboard of the vehicle. A length of the surface gap defined between the interior surface feature and the dashboard decreases as the interior surface feature moves toward the dashboard. In even further implementations, the surface gap prevents the airbag from occupying the inflation region when the interior surface feature is in the nominal position. In other further implementations, when the interior surface feature is in the second position, the interior surface feature is in a retracted position coplanar with the dashboard.

In some examples, the actuator includes a linear actuator configured to actuate between an extended position and a retracted position. In further examples, the linear actuator is in one of the extended position or the retracted position when the interior surface feature is in the first position and is in the other one of the extended position or the retracted position when the interior surface feature is in the second position. In other further examples, operating the actuator to move the interior surface feature from the first position to the second position includes operating the linear actuator to actuate from one of the extended position or the retracted position to the other one of the extended position or the retracted position.

The interior surface feature may include a display screen of the vehicle. Optionally, the actuator is further operable to adjust an angle of the display screen relative to a dashboard of the vehicle.

In some implementations, when the interior surface feature is in the first position, the interior surface feature is in a nominal position retracted toward a dashboard of the vehicle. When the actuator is moving the interior surface feature from the first position to the second position, the interior surface feature moves away from the dashboard. In further implementations, a cavity is defined between the interior surface feature and an interior floor of the vehicle when the interior surface feature is in the nominal position. The cavity prevents the airbag from occupying the inflation region when the interior surface feature is in the nominal position. A volume of the cavity defined between the interior surface feature and the interior floor of the vehicle reduces as the interior surface feature moves away from the dashboard. Optionally, the interior surface feature includes a knee bolster panel.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of a vehicle.

FIG. 2 is a perspective view of an interior cabin of the vehicle, showing a display screen in a nominal position relative to a dashboard of the vehicle.

FIG. 3A is a perspective sectional view taken along the line III-III of FIG. 2.

FIG. 3B is a cross sectional view taken along the line III-III of FIG. 2.

FIG. 3C is a perspective sectional view taken along the line III-III of FIG. 2, showing an airbag in a deployed state with the display screen in the nominal position.

FIG. 4 is a perspective view of the interior cabin of the vehicle, showing the display screen moved to a retracted position relative to the dashboard via an actuator.

FIG. 5A is a perspective sectional view taken along the line V-V of FIG. 4.

FIG. 5B is a cross sectional view taken along the line V-V of FIG. 4.

FIG. 5C is a perspective sectional view taken along the line V-V of FIG. 4, showing the airbag in the deployed state with the display screen in the retracted position.

FIG. 6 is a perspective view of the interior cabin of the vehicle, showing a knee bolster panel in a nominal position relative to the dashboard.

FIG. 7A is a perspective sectional view taken along the line VII-VII of FIG. 6.

FIG. 7B is a cross sectional view taken along the line VII-VII of FIG. 6, showing the airbag in the deployed state with the knee bolster panel in the nominal position.

FIG. 8 is a perspective view of the interior cabin of the vehicle, showing the knee bolster panel moved to an extended position relative to the dashboard via the actuator.

FIG. 9A is a perspective sectional view taken along the line IX-IX of FIG. 8.

FIG. 9B is a cross sectional view taken along the line IX-IX of FIG. 8, showing the airbag in the deployed state with the knee bolster panel in the extended position.

FIG. 10 is a flowchart of an exemplary arrangement of operations for a method of operating the actuator to move an interior surface feature from a nominal first position to a second position to accommodate deployment of the airbag.

FIG. 11 is a schematic view of an example computing device that may be used to implement the systems and methods described herein.

Like reference symbols in the various drawings indicate like elements.

### DETAILED DESCRIPTION

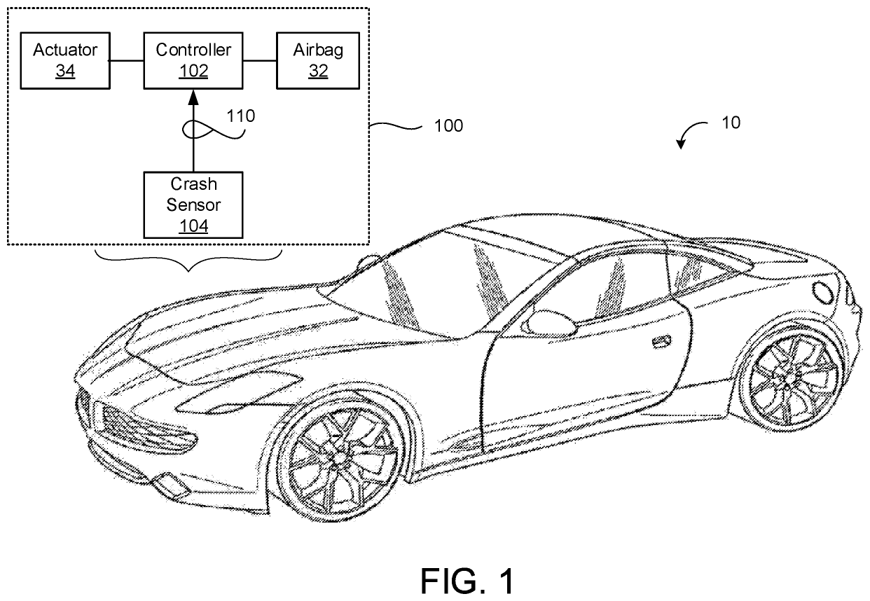

Referring to FIGS. 1-9A, a vehicle 10, such as a battery-powered electric or plug-in hybrid vehicle, includes one or more airbag modules 30 disposed at an interior portion or cabin 12 of the vehicle 10. In the illustrated example, the airbag module 30 is disposed at a passenger side of a dashboard region 14 of the cabin 12 and behind an airbag door panel 20 of the dashboard 16. In a default or non-deployed state, such as when the vehicle 10 is in normal operation, an airbag 32 of the airbag module 30 is compactly stored or concealed behind the door panel 20. When the airbag 32 is deployed to an actuated or deployed state, such as in response to the vehicle experiencing a collision, the airbag module 30 operates to rapidly inflate the airbag 32 so that the airbag 32 occupies an inflation region 33 between vehicle occupants and interior surfaces of the vehicle 10 at the dashboard 16. Thus, the interior surfaces provide reaction surfaces for the airbag 32 to effectively protect the vehicle occupants by cushioning the surfaces and absorbing forces of the collision experienced by the occupants.

It should be understood that the airbag module 30 may be disposed at any suitable position of the vehicle 10 and configured to inflate the airbag 32 in response to a vehicle collision. For example, the airbag module 30 may be disposed at or within the steering wheel 22 of the vehicle 10, at respective driver and passenger sides of the cabin 12 (e.g., curtain airbags), at respective driver and passenger side knee regions 24 of the cabin 12, between the driver and passenger sides of the cabin 12, at a rear seat region of the cabin 12, at a sunroof region of the cabin 12, and one or more exterior positions of the vehicle 10.

When the airbag 32 is deployed, interior surface features 18 at the dashboard 16 and near the airbag module 30 must cooperate with the dashboard 16 to provide a smooth and continuous contour so that deployment of the airbag 32 is not obstructed and the inflated airbag 32 may occupy its intended inflation region 33, where the inflated airbag 32 is disposed between occupants of the vehicle and the dashboard 16 and interior surface features 18 so that the dashboard 16 and interior surface features 18 provide effective reaction surfaces for the airbag 32. That is, interior surface features 18 that disrupt the smooth contour of the dashboard 16 may cause issues with airbag deployment such that the inflated airbag 32 is not fully and/or effectively positioned between the vehicle occupants and the surfaces. For example, gaps between surfaces (such as gaps of two or three inches or less) are a key feature that may cause airbag deployment issues. Thus, the dashboard 16 and interior surface features 18 provide a smooth and substantially uninterrupted surface or contour at or near the airbag module 30 when the airbag 32 is deployed. However, before the airbag 32 is deployed, the interior surface features 18 may present a potential obstruction for inflation of the airbag 32. Therefore, and as described below, the vehicle 10 is equipped with an actuator or adjustment mechanism 34 coupled to one or more surface features 18 of the vehicle 10 and operable to, when a vehicle collision occurs and the airbag 32 is deployed, adjust positioning or configuration of the coupled surface feature 18 so that deployment of the airbag 32 is not obstructed and the airbag 32 safely and reliably inflates as intended.

Thus, the actuator 34 allows for modern interior design of vehicle cabins to include one or more interior surface features 18 that, if left in a default state, would otherwise interfere with airbag deployment. In other words, the actuator 34 reduces or eliminates constraints placed by safety requirements that inhibit design and styling freedom. Design features previously determined as not feasible may now be safely implemented in vehicle interiors. Specifically, the actuator 34 enables the adjustment of interior surface features 18 to optimize safety performance and maintain high standards of crash safety while expanding interior design freedom.

To accommodate the rapid deployment of the airbag 32 when a vehicle collision occurs and the airbag is deployed from the non-deployed state to the deployed state, the actuator 34 includes a pyrotechnical or high-energy deployable device that is operable to quickly adjust configuration or positioning of the coupled interior surface feature 18 when the collision is sensed. The actuator 34 adjusts the coupled interior surface feature 18 before and/or as the airbag 32 is deployed so that the airbag 32 may deploy over and along the adjusted interior surface feature 18 to occupy the inflation region 33. In the illustrated example, the actuator 34 includes a piston-style mechanism or linear actuator 36 and is linked to the safety systems of the vehicle 10 so that the piston mechanism 36 actuates when the collision is sensed.

At a first end 38, the actuator 34 is coupled to or anchored to a static structural member 42 of the vehicle 10. For example, the first end 38 is mounted to a portion of the vehicle frame disposed behind the dashboard 16 of the vehicle 10. The actuator 34 is coupled to the adjustable interior surface feature 18 of the vehicle 10 at a second, opposite end 40 of the actuator 34. When the actuator 34 is in its first or nominal position (i.e., when the airbag 32 is in the non-deployed state and the vehicle is being operated normally), the interior surface feature 18 is in its first or nominal position and provides its intended function at the cabin 12 of the vehicle 10. Thus, the actuator 34 may act as a structural support member for the coupled interior surface feature 18. Some applications may require additional structural support for the coupled interior surface feature 18 when the actuator 34 is in its nominal position. When the piston 36 is actuated and the actuator 34 is adjusted from its nominal position to its second or actuated position (i.e., when a vehicle collision is sensed and the airbag 32 is being deployed), the actuator 34 moves the coupled interior surface feature 18 relative to the dashboard 16 and structural member 42 to provide the desired airbag reaction surface. In other words, movement of the actuator 34 from its first position to its second position moves the interior surface feature 18 from its first position to a second or adjusted position, where the airbag 32 may inflate over and in front of the interior surface feature 18 and dashboard 16.

When the actuator 34 is in its first or nominal position, the adjustable interior surface feature 18 is in its first or nominal position, where the interior surface feature 18 provides a potential obstruction for inflation of the airbag 32. In other words, when the adjustable interior surface feature 18 is in its first position, the airbag 32 is at least partially prevented from occupying the inflation region 33 when the airbag 32 deploys. When the actuator 34 is moved to its second or actuated position, the interior surface feature 18 is moved to its second position, where the interior surface feature 18 does not obstruct inflation of the airbag 32. That is, when the interior surface feature 18 is in its second position, the airbag 32 is permitted to occupy the inflation region 33 when the airbag 32 deploys. The actuator 34 may operate to move or adjust the interior surface feature 18 in any suitable direction relative to static portions of the dashboard 16, such as to retract the surface feature 18, extend the surface feature 18, or shift the surface feature 18 relative to the dashboard 16.

In some implementations, the actuator 34 is operable to retract the coupled interior surface feature 18 relative to the dashboard 16 and the structural member 42. In other words, when the actuator 34 is in its nominal position, the coupled interior surface feature 18 is in its first position and protrudes from the dashboard 16 and obstructs the inflated airbag 32 such that the airbag 32 is unable to occupy the inflation region 33 between the occupant of the vehicle 10 and the coupled interior surface feature 18, thus endangering the occupant during the vehicle collision. The actuator 34 is thus actuated in response to the sensed collision and moves the coupled interior surface feature 18 from its first position and away from the inflation region 33 and toward the dashboard 16 to a retracted or second position to allow the inflated airbag 32 to occupy the region between the vehicle occupant and the interior surface feature 18.

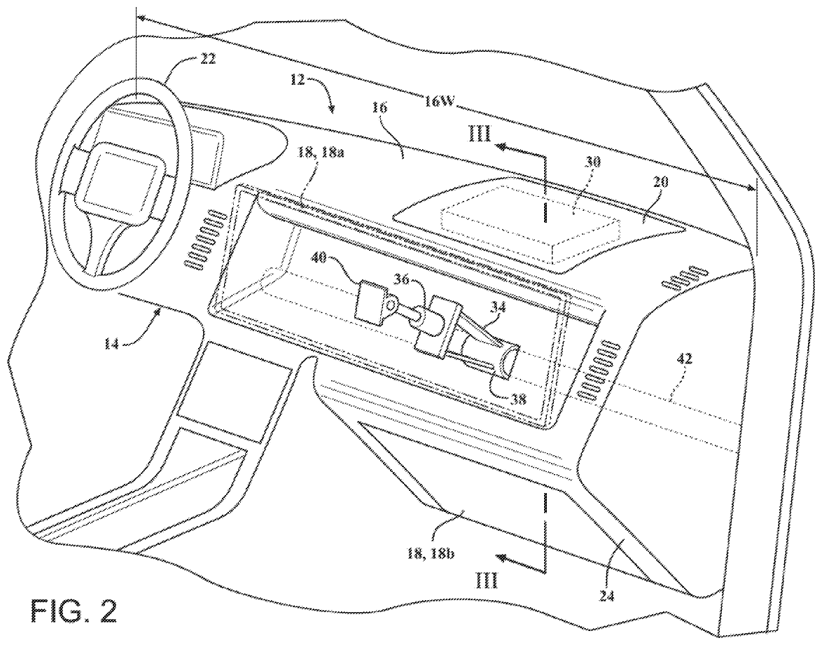

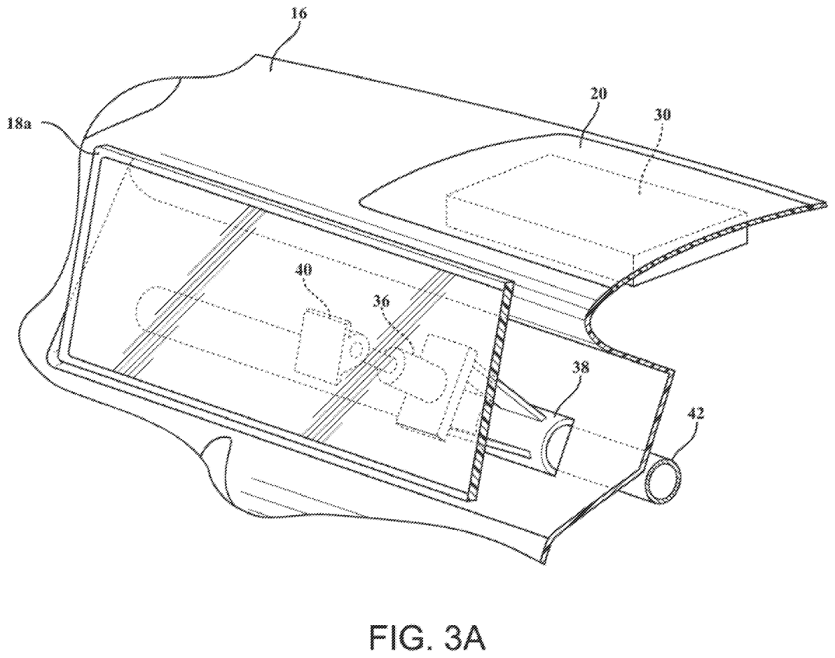

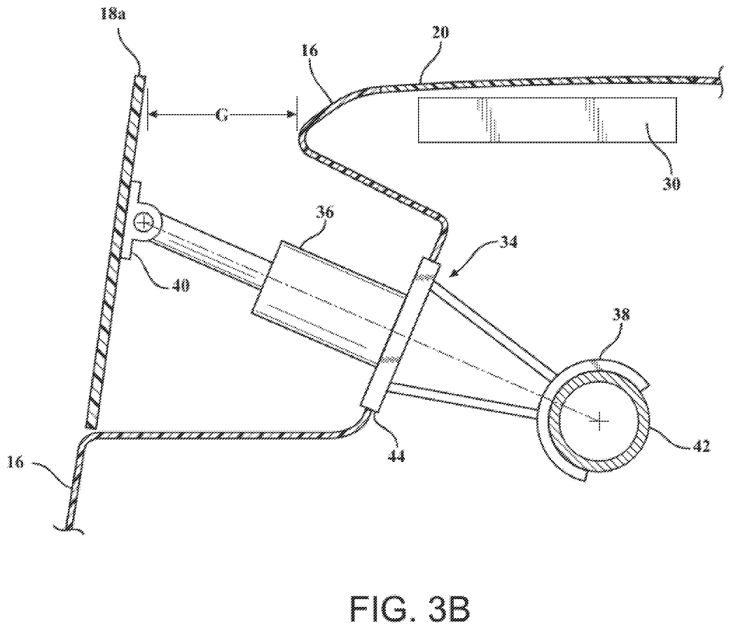

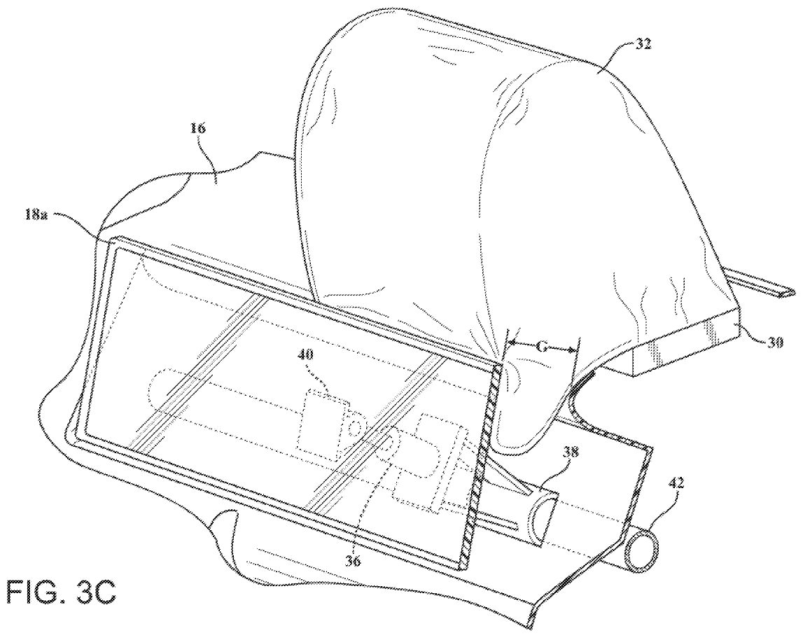

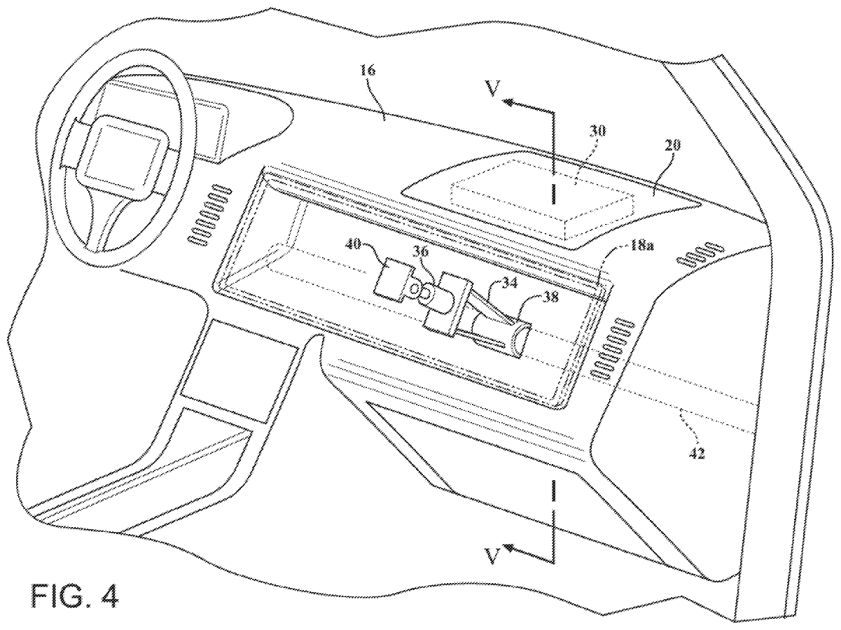

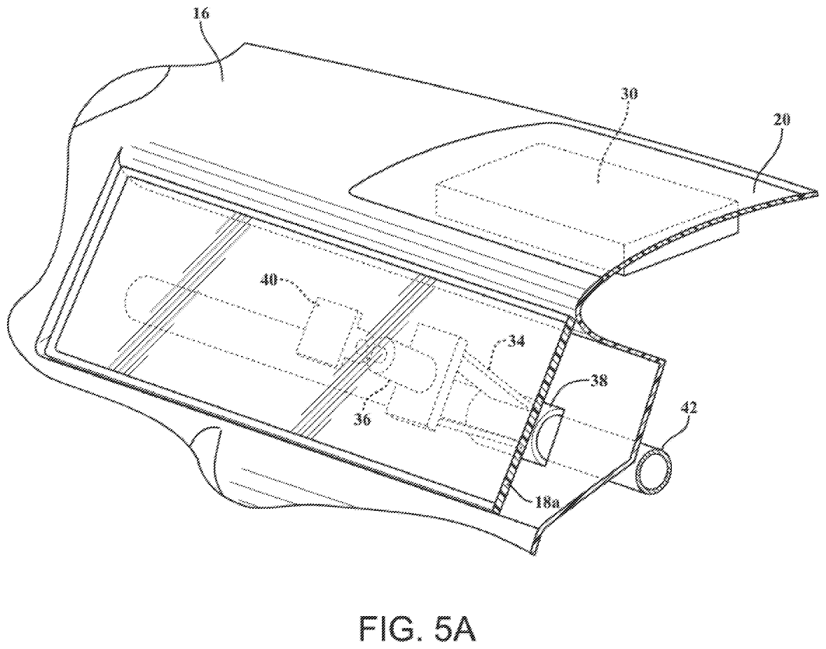

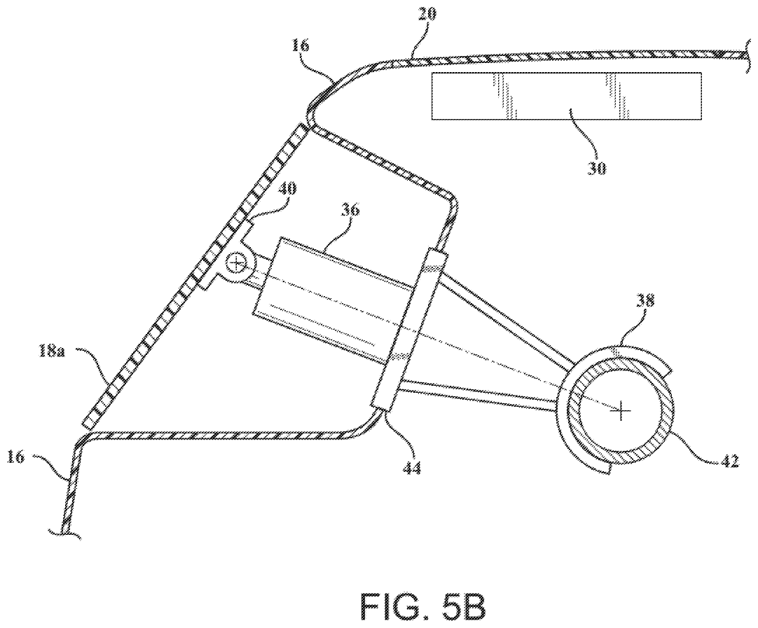

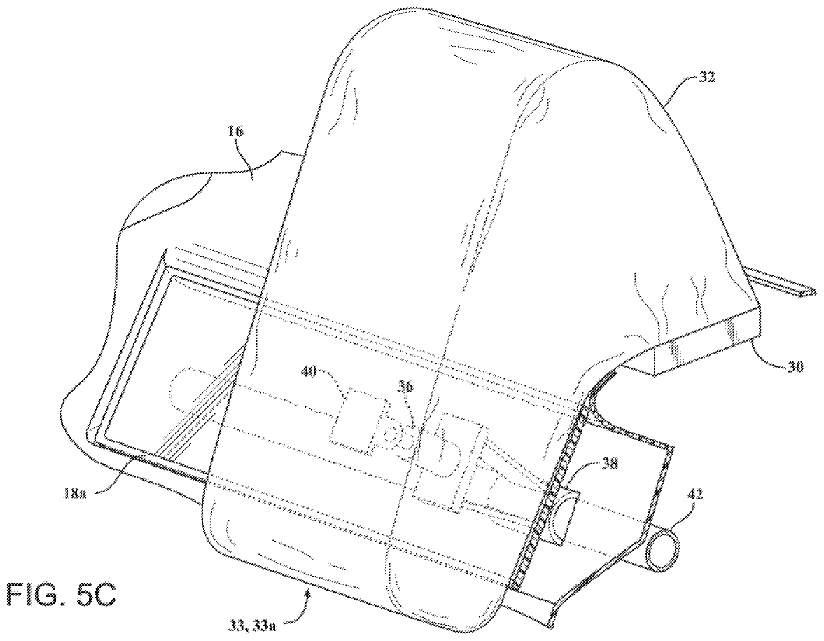

Referring to FIGS. 2-5C, in some implementations, the interior surface feature 18 includes an interactive user interface or display screen assembly 18, 18a (such as an infotainment touchscreen device or module) that extends from the dashboard 16 of the vehicle 10. The display screen 18a extends along a width 16 W of the dashboard 16 and at least partially along a passenger side of the dashboard 16 and in front of a passenger side seat. Thus, the display screen 18a is disposed between the airbag module 30 and the passenger side seat. The display screen 18a is coupled to the second end 40 of the actuator 34 and is adjustable between a first or extended or nominal position (FIGS. 2 and 3A-3C), where the display screen 18a protrudes from the dashboard 16, and a second or retracted position (FIGS. 4 and 5A-5C), where the display screen 18a is moved toward the dashboard 16 (and optionally, coplanar with the dashboard 16) via operation of the actuator 34.

As shown in FIGS. 3A and 3B, the actuator 34 mounts to the structural member 42 of the vehicle at the first end 38 and extends through a portion of the dashboard 16 behind the display screen 18a to mount to the display screen 18a at the second end 40. In the illustrated example, the piston 36 extends from a surface or housing 44 that is connected to and/or flush with the portion of the dashboard 16 behind the display screen 18a, with the first end 38 extending from the housing 44 within or behind the dashboard 16 to mount to the vehicle structural member 42. Because the display screen 18a is extended or raised or protruding relative to the dashboard 16 in the nominal position (e.g., FIGS. 2 and 3A-3C), a space or gap G is present between the display screen 18a and the surface 18 of the dashboard 16. The housing 44 that is flush with or connected to the dashboard 16 behind the display screen 18a restricts or prevents access to the area within or behind the dashboard 16 through the gap G.

Furthermore, when the display screen 18a is in the nominal position, the display screen 18a extends from the dashboard 16 and obstructs inflation of the airbag 32. That is, the display screen 18a in the nominal position is proud of the dashboard 16 and the display screen 18a may extend at any suitable angle relative to the dashboard 16, such as a non-right or oblique angle, or at a right angle. Thus, and as shown in FIG. 3C, if the airbag 32 is deployed with the display screen 18a in the nominal position, the airbag 32 may catch on the display screen 18a and/or get stuck in the gap G, therefore preventing the airbag 32 from occupying the region between the display screen 18a and the vehicle occupants.

When the vehicle collision is sensed, the actuator 34 moves or retracts the display screen 18a from the nominal position toward the retracted position (e.g., FIGS. 4 and 5A-5C), where the display screen 18a is moved toward the dashboard 16. That is, the linear actuator piston 36 actuates to pull the display screen 18a toward the dashboard 16 to reduce or eliminate the gap G between the display screen 18a and the dashboard surface 18 so that the airbag 32 properly inflates over and along the display screen 18a to be disposed in the inflation region 33, 33a between the display screen 18a and the vehicle occupant (e.g., FIG. 5C).

FIG. 3C depicts the inflation of the airbag 32 with the display screen 18a in the first or extended position and FIG. 5C depicts the inflation of the airbag 32 with the display screen 18a in the second or retracted position. As shown, with the display screen 18a in the retracted position, the airbag 32 occupies the inflation region 33a between the display screen 18a and the vehicle occupant and thus protects the vehicle occupant from an impact with the display screen 18a and other portions of the dashboard 16. That is, the display screen 18a provides an effective reaction surface for the inflated airbag 32 and protection of the vehicle occupant is optimized with the airbag 32 occupying the inflation region 33a. With the display screen 18a in the extended position, the airbag 32 catches on the display screen 18a as it inflates and the airbag 32 inflates at least partially into the gap G and is thus at least partially prevented from occupying the inflation region 33a. In other words, the airbag 32 is at least partially prevented from occupying the inflation region 33a with the display screen 18a in the extended position and thus the airbag 32 does not have an effective reaction surface to provide optimized protection for the vehicle occupant.

As shown in FIG. 5B, the second end 40 of the actuator 34 is pivotally connected to the display screen 18a so that, when the actuator 34 is actuated, the display screen 18a may pivotally adjust relative to the piston 36 as the display screen 18a is pulled toward the dashboard 16. In the illustrated example, the display screen 18a is substantially flush or coplanar with the adjacent portions of the dashboard 16 at and around the display screen 18a to provide the smooth airbag reaction surface. In other words, the display screen 18a is pulled toward the dashboard 16 and pivotally adjusts relative to the actuator 34 to conform to the dashboard 16 and, in the retracted position, the display screen 18a is substantially flush with the dashboard 16 so that the airbag 32 properly inflates over and along the display screen 18a into the inflation region 33a. Furthermore, when the display screen 18a is in the nominal position, the actuator 34 may be operated to a lesser degree to adjust an angle of the display screen 18a relative to the dashboard 16. For example, the driver actuates a user actuatable input to adjust a viewing angle of the display screen 18a relative to the driver. Thus, the actuator 34 provides a variable angle adjustment feature for nominal or default use of the display screen 18a and the complete retraction feature when the vehicle collision is sensed and the actuator 34 retracts the display screen 18a a predetermined distance. Optionally, the display screen 18a is stored in the retracted position (such as when the vehicle 10 is shut off and/or the display screen 18a are not being operated) and the actuator 34 extends the display screen 18a to the nominal position when the display screen 18a is in use.

In some implementations, the actuator 34 is operable to extend the coupled interior surface feature 18 relative to the dashboard 16 and the structural member 42. In other words, when the actuator 34 is in its nominal position, the coupled interior surface feature 18 is in its first position and is recessed from the dashboard 16 and allows the airbag 32 to inflate away from the vehicle occupant, such as into an empty space or void defined by the interior surface feature 18, and the airbag 32 fails to occupy an entirety of the designated inflation region 33 between the occupant of the vehicle 10 and the interior surface features 18. The actuator 34 is thus actuated in response to the sensed collision and moves the coupled interior surface feature 18 from its first position and toward the airbag 32 and the inflation region 33 and, optionally, away from the dashboard 16 to an extended or second position to allow the inflated airbag 32 to properly occupy the designated inflation region 33 between the vehicle occupant and the interior surface feature 18.

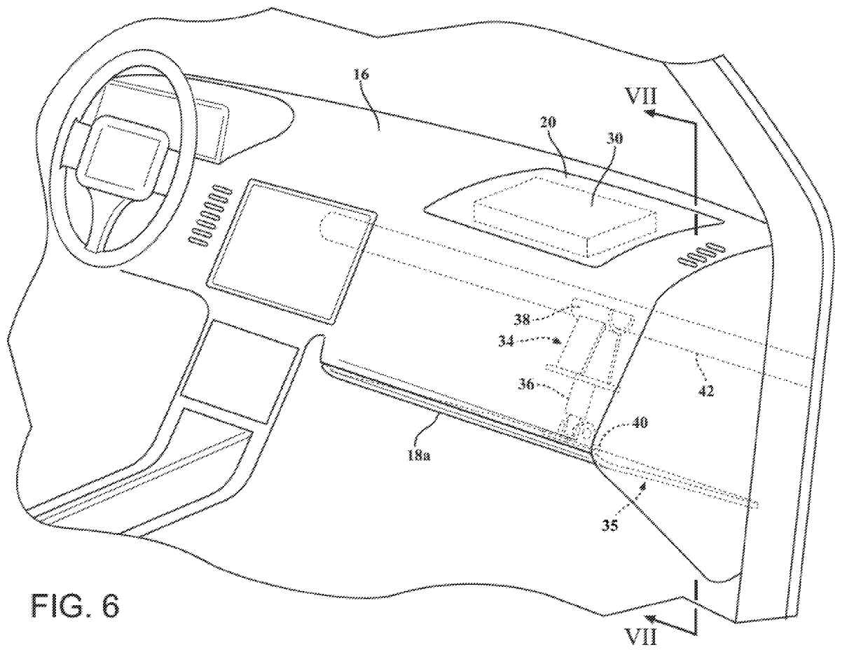

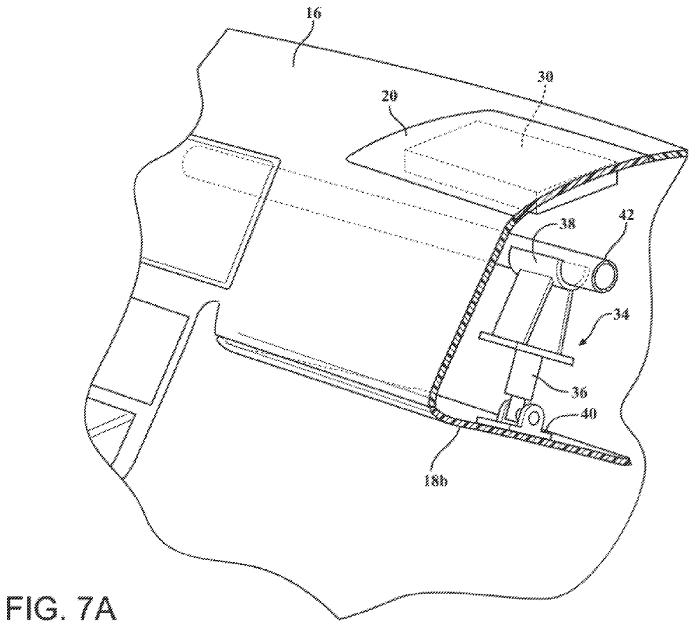

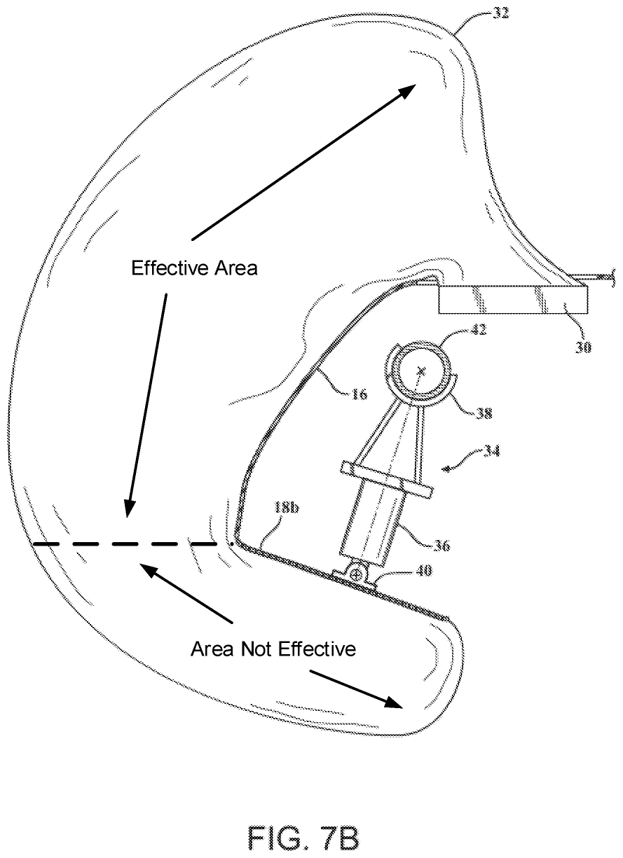

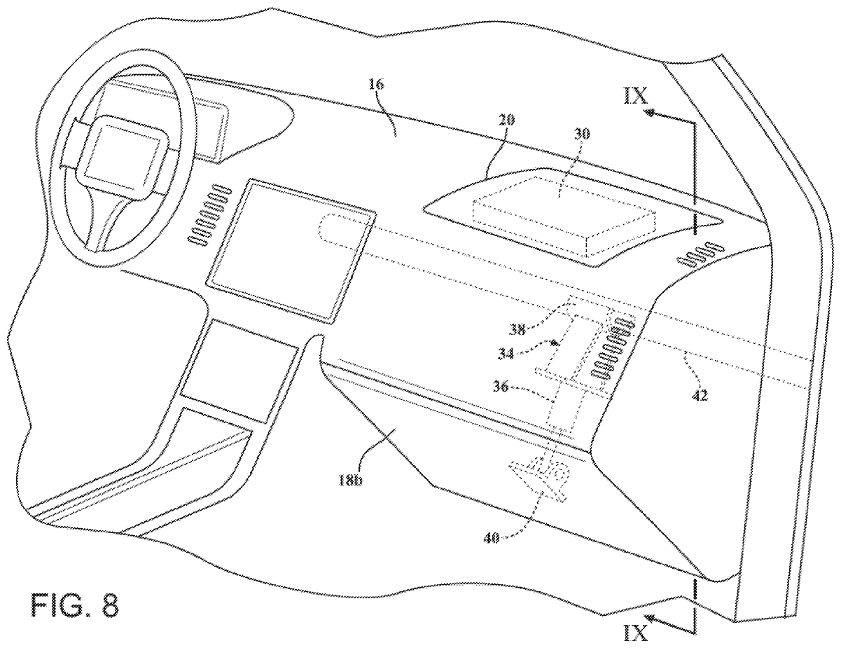

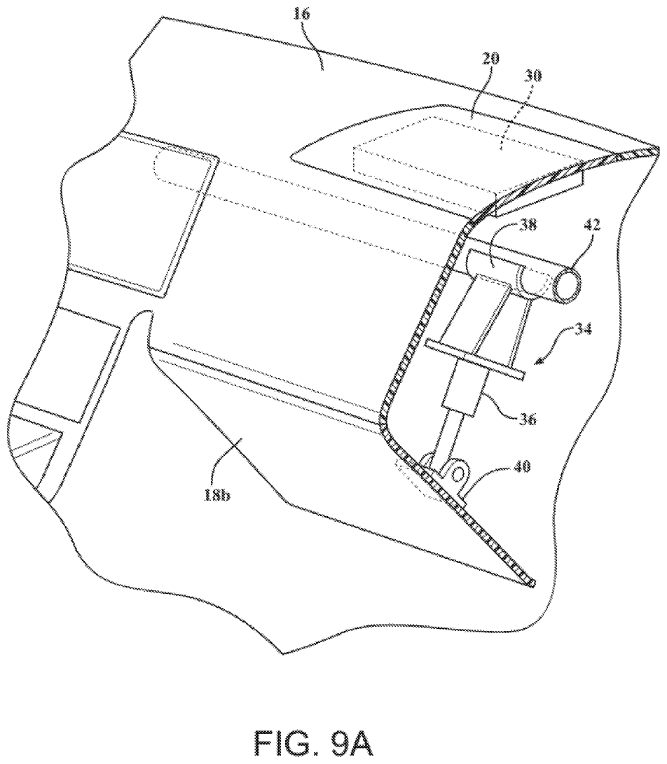

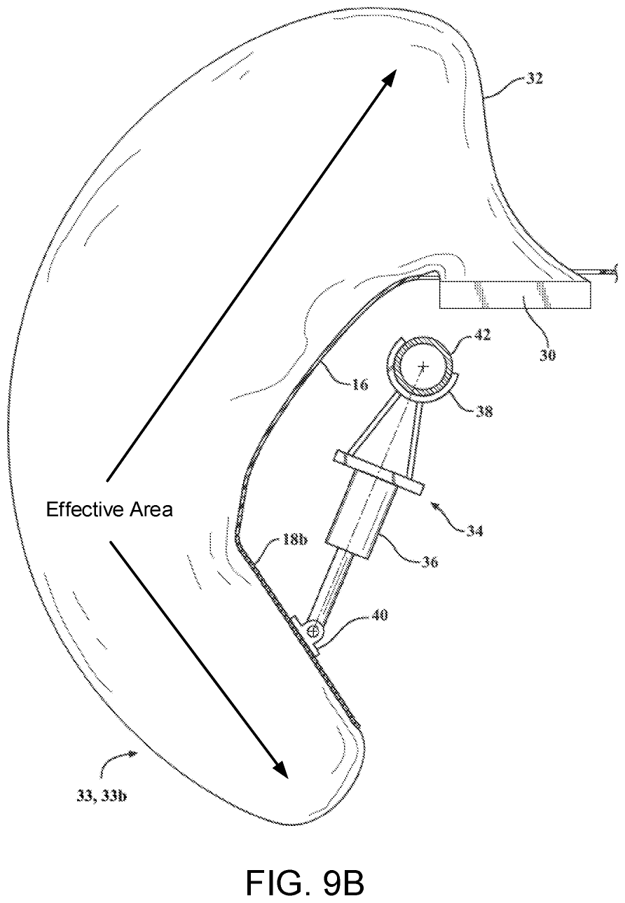

Referring now to FIGS. 6-9B, the interior surface feature 18 includes a knee bolster panel 18, 18b that extends below the dashboard 16 of the vehicle 10 along the passenger side of the cabin 12 and defines a foot well at the passenger side. In a first or nominal position, the knee bolster panel 18b is disposed along an inflation path of the airbag 32 between the airbag module 30 and the passenger side seat and defines a cavity or space 35 that the airbag 32 may inflate into when deployed. If the airbag 32 follows the inflation path and is allowed to inflate into the cavity 35 when deployed, the airbag 32 will be thwarted from occupying an entirety of the inflation region 33, 33b required to properly protect the occupant of the vehicle. In other words, the reaction surface for the airbag 32 is recessed from an optimal position and thus, while the airbag 32 may still provide protection for the occupant when the airbag 32 inflates partially into the cavity 35, protection is not optimized. The knee bolster panel 18b is coupled to the second end 40 of the actuator 34 and is movable between the nominal position (i.e., first position) (FIGS. 6, 7A, and 7B) and an extended position (i.e., second position) (FIGS. 8, 9A, and 9B) via operation of the actuator 34.

In some implementations, the actuator 34 mounts to the structural member 42 of the vehicle at the first end 38 and extends within or behind the dashboard 16 to mount to the knee bolster panel 18b at the second end 40. In other words, the actuator 34 is contained entirely within the dashboard 16 and is not exposed to the cabin 12 of the vehicle 10. Because the knee bolster panel 18b is retracted or recessed relative to the dashboard 16 in the nominal position (e.g., FIGS. 6, 7A, and 7B), the cavity 35 or recess is present at or below the dashboard 16. That is, the cavity 35 is defined between the knee bolster panel 18b and an occupant seat or floor surface (not shown) of the interior cabin 12.

Thus, with the knee bolster panel 18b in the nominal position, deployment of the airbag module 30 would cause the airbag 32 to inflate into or toward the cavity 35 below the dashboard 16, thereby displacing the inflated airbag 32 from the ability to occupy the entire inflation region 33b required to properly protect the occupant of the vehicle. For example, see FIG. 7B, where the inflated airbag 32 wraps around the smooth surface of the dashboard 16 and follows the contoured surface along the knee bolster panel 18b beneath the dashboard 16 to occupy the cavity 35.

When the vehicle collision is sensed, the actuator 34 moves or extends the knee bolster panel 18b from the nominal position toward an extended position (i.e., second position) (e.g., FIGS. 8, 9A, and 9B), where the knee bolster panel 18b is moved away from the dashboard 16. That is, the linear actuator piston 36 actuates to push the knee bolster panel 18b to the extended position away from the dashboard 16 to reduce or eliminate the cavity 35 beneath the dashboard 16, and thus, direct the airbag 32 to properly inflate into the entire inflation region 33b between the dashboard 16 and the vehicle occupant (e.g., FIG. 9B).

FIG. 7B depicts the inflation of the airbag 32 with the knee bolster panel 18b in the first or retracted position and FIG. 9B depicts the inflation of the airbag with the knee bolster panel 18b in the second or extended position. As shown, with the knee bolster panel 18b in the extended position, the airbag 32 fully or properly occupies the inflation region 33b between the dashboard 16 and knee bolster panel 18b and the vehicle occupant and thus protects the vehicle occupant from an impact with the dashboard 16 and knee bolster panel 18a compared to when the airbag 32 does not fully or properly occupy the inflation region 33b. That is, the knee bolster panel 18b provides an effective reaction surface for the inflated airbag 32 and protection of the vehicle occupant is optimized with the airbag 32 fully occupying the inflation region 33b. With the knee bolster panel 18b in the retracted position, the airbag 32 inflates at least partially into the cavity 35 defined by the retracted knee bolster panel 18b and is thus at least partially prevented from fully occupying the inflation region 33b. In other words, the cavity 35 reduces or eliminates at least part of the reaction surface for the airbag 32 and at least partially prevents the airbag 32 from occupying the inflation region 33b with the knee bolster panel 18b in the retracted position and thus the airbag 32 is more effective along the dashboard 16 and less effective or ineffective within the cavity 35 along the knee bolster panel 18b in FIG. 7B. With the knee bolster panel 18b in the extended position, the volume of the cavity 35 is reduced so that the airbag 32 inflates properly or more fully into the inflation region 33b and thus the airbag 32 is largely effective across the entirety of the airbag 32 in FIG. 9B.

As shown in FIG. 9B, the second end 40 of the actuator 34 is pivotally connected to the knee bolster panel 18b so that, when the actuator 34 actuates from a retracted position to an extended position, the knee bolster panel 18b may pivotally adjust relative to the piston 36 as the knee bolster panel 18b is pushed away from the dashboard 16. In the illustrated example, the knee bolster panel 18b is integrally formed with the stationary surfaces of the dashboard 16 and pivotal or flexible relative to the dashboard 16 so that, when the actuator 34 moves the knee bolster panel 18b to the extended position (i.e., second position), the knee bolster panel 18b pivots relative to the piston 36 and the dashboard 16. Thus, the dashboard 16 and the knee bolster panel 18b provide a substantially continuous and smooth contour for the airbag to inflate over and along. Optionally, the adjustable panel 18b is a separate surface or panel of the dashboard 16, such as a glovebox compartment or other interior surface defining a cavity in which the airbag 32 may inflate.

Furthermore, when the knee bolster panel 18b is in the nominal position, the actuator 34 may be operated to a lesser degree to adjust an angle of the knee bolster panel 18b relative to the dashboard 16. For example, the occupant actuates a user actuatable input to adjust an angle of the knee bolster panel 18b to adjust the space provided in the foot well. Thus, the actuator 34 provides a variable angle adjustment feature for nominal or default use of the knee bolster panel 18b and the complete extension feature when the vehicle collision is sensed and the actuator 34 extends the knee bolster panel 18b a predetermined distance.

Thus, the actuator 34 automatically extends or retracts an interior surface feature 18 of the vehicle 10 in response to sensing a vehicle collision so that one or more airbags 32 can properly deploy and inflate without obstruction or interference from the adjustable interior surface features. This maintains strict crash safety protocols while expanding possibilities for new interior designs and functionality.

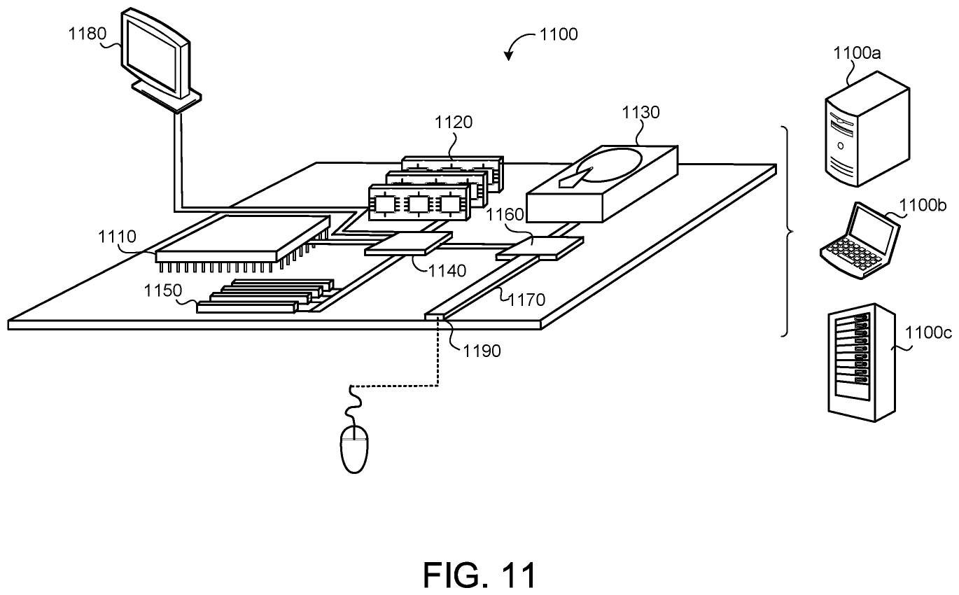

Referring back to FIG. 1, a safety system 100 of the vehicle 10 actuates the actuator 34 in response to sensing or determining that the vehicle 10 is experiencing a collision or that a collision is imminent. The safety system 100 includes a controller 102, the actuator 34, one or more crash sensors 104, and the airbag 32 deployable from a non-deployed state to a deployed state. The controller 102 may execute on data processing hardware 1110 (FIG. 11) of the vehicle 10 based on instructions stored on memory hardware 1120 (FIG. 11) in communication with the data processing hardware. The crash sensor 104 may be disposed on the vehicle and include an impact sensor that detects impacts to the vehicle indicative of a collision/crash. The crash sensor 104 may send a crash notification signal 110 to the controller 102 indicating that the vehicle 10 is experiencing a crash. Based on the crash notification signal 110, the controller 102 may cause the airbag 32 to deploy and the actuator 34 to actuate from one of the retracted position or the extended position to the other one of the retracted position or the extended position to move the interior surface feature 18 from the nominal first position to the second position. In some examples, the crash sensor 104 includes a radar, lidar, or camera configured to provide data indicating a distance between the vehicle and an object. Here, controller 102 may receive the data and determine that a crash is imminent and instruct the actuator 34 to actuate from one of the retracted position or the extended position to the other one of the retracted position or the extended position to cause the interior surface feature 18 to move from the nominal first position to the second position in anticipation of deployment of the airbag 32.

For example, the vehicle 10 includes data processing hardware 1110 (FIG. 11) and memory hardware 1120 (FIG. 11) in communication with the data processing hardware 1110. The memory hardware 1120 stores instructions that, when executed on the data processing hardware 1110, cause the data processing hardware 1110 to perform operations. For example, the memory hardware 1120 stores instructions for operating the actuator 34 when the collision is sensed. The data processing hardware 1110 and memory hardware 1120 may further be configured to provide the safety system of the vehicle that is configured to sense or determine that the vehicle is experiencing the collision, or the data processing hardware 1110 and memory hardware 1120 may be in communication with the safety system and receive a signal from the safety system indicating that the vehicle is experiencing the collision. The signal may further indicate that the airbag 32 is being deployed or has deployed.

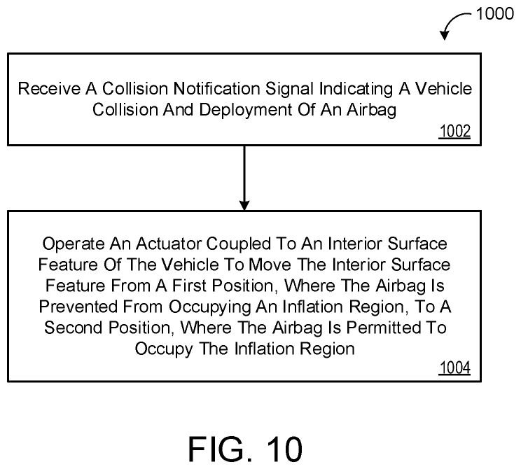

FIG. 10 provides a flowchart of an exemplary arrangement of operations for a method 1000 of controlling operation of the actuator 34 that is coupled to the interior surface feature 18 of the vehicle 10. The vehicle 10 includes the airbag 32 disposed within the interior cabin 12 of the vehicle 10 that is deployable from the non-deployed state to the deployed state, where the airbag 32 is configured to occupy the inflation region 33 within the interior cabin 12 while in the deployed state. The interior surface feature 18 is movable between the first position and the second position, where the airbag 32 is prevented from occupying the inflation region 33 when the interior surface feature 18 is in the first position. The actuator 34 is coupled to the interior surface feature 18 and is configured to move the interior surface feature 18 from the first position to the second position. The controller 102 of the safety system 100 may perform the operations for the method 1000. At operation 1002, the method 1000 includes receiving a collision notification signal that indicates that the vehicle 10 has experienced a collision. At operation 1004, based on receiving the collision notification signal, the method 1000 includes operating the actuator 34 to move the interior surface feature 18 from the first position to the second position to permit the airbag 32 to occupy the inflation region 33 within the interior cabin 12 of the vehicle 10.

FIG. 11 is schematic view of an example computing device 1100 that may be used to implement the systems and methods described in this document. The computing device 1100 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document. For example, the computing device 1100 may be disposed at the vehicle 10 or remote from the vehicle 10.

The computing device 1100 includes a processor 1110, memory 1120, a storage device 1130, a high-speed interface/controller 1140 connecting to the memory 1120 and high-speed expansion ports 1150, and a low speed interface/controller 1160 connecting to a low speed bus 1170 and a storage device 1130. Each of the components 1110, 1120, 1130, 1140, 1150, and 1160, are interconnected using various busses, and may be mounted on a common motherboard or in other manners as appropriate. The processor 1110 can process instructions for execution within the computing device 1100, including instructions stored in the memory 1120 or on the storage device 1130 to display graphical information for a graphical user interface (GUI) on an external input/output device, such as display 1180 coupled to high speed interface 1140. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1120 stores information non-transitorily within the computing device 1100. The memory 1120 may be a computer-readable medium, a volatile memory unit(s), or non-volatile memory unit(s). The non-transitory memory 1120 may be physical devices used to store programs (e.g., sequences of instructions) or data (e.g., program state information) on a temporary or permanent basis for use by the computing device 1100. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1130 is capable of providing mass storage for the computing device 1100. In some implementations, the storage device 1130 is a computer-readable medium. In various different implementations, the storage device 1130 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1120, the storage device 1130, or memory on processor 1110.

The high speed controller 1140 manages bandwidth-intensive operations for the computing device 1100, while the low speed controller 1160 manages lower bandwidth-intensive operations. Such allocation of duties is exemplary only. In some implementations, the high-speed controller 1140 is coupled to the memory 1120, the display 1180 (e.g., through a graphics processor or accelerator), and to the high-speed expansion ports 1150, which may accept various expansion cards (not shown). In some implementations, the low-speed controller 1160 is coupled to the storage device 1130 and a low-speed expansion port 1190. The low-speed expansion port 1190, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1100a or multiple times in a group of such servers 1100a, as a laptop computer 1100b, or as part of a rack server system 1100c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving a collision notification signal indicating that a vehicle has experienced a collision, the vehicle comprising:
an airbag disposed within an interior cabin of the vehicle and deployable from a non-deployed state to a deployed state, the airbag configured to occupy an inflation region within the interior cabin of the vehicle while in the deployed state;
an interior surface feature movable between a first position and a second position, wherein the airbag is prevented from occupying the inflation region when the interior surface feature is in the first position; and
an actuator coupled to the interior surface feature and configured to move the interior surface feature from the first position to the second position when the airbag deploys from the non-deployed state to the deployed state; and
based on receiving the collision notification signal, operating the actuator to move the interior surface feature from the first position to the second position to permit the airbag to occupy the inflation region within the interior cabin of the vehicle.

2. The method of claim 1, wherein:
when the interior surface feature is in the first position, the interior surface feature is in a nominal position that protrudes from a dashboard of the vehicle; and
when the actuator is moving the interior surface feature from the first position to the second position, the interior surface feature moves toward the dashboard.

3. The method of claim 2, wherein:
a surface gap is defined between the interior surface feature and the dashboard of the vehicle when the interior surface feature is in the nominal position that protrudes from the dashboard of the vehicle; and
a length of the surface gap defined between the interior surface feature and the dashboard decreases as the interior surface feature moves toward the dashboard.

4. The method of claim 3, wherein the surface gap prevents the airbag from occupying the inflation region when the interior surface feature is in the nominal position.

5. The method of claim 2, wherein, when the interior surface feature is in the second position, the interior surface feature is in a retracted position coplanar with the dashboard.

6. The method of claim 1, wherein the actuator comprises a linear actuator configured to actuate between an extended position and a retracted position.

7. The method of claim 6, wherein the linear actuator is in one of the extended position or the retracted position when the interior surface feature is in the first position and is in the other one of the extended position or the retracted position when the interior surface feature is in the second position.

8. The method of claim 6, wherein operating the actuator to move the interior surface feature from the first position to the second position comprises operating the linear actuator to actuate from one of the extended position or the retracted position to the other one of the extended position or the retracted position.

9. The method of claim 1, wherein the interior surface feature comprises a display screen of the vehicle.

10. The method of claim 9, wherein the actuator is further operable to adjust an angle of the display screen relative to a dashboard of the vehicle.

11. The method of claim 1, wherein:
when the interior surface feature is in the first position, the interior surface feature is in a nominal position retracted toward a dashboard of the vehicle; and
when the actuator is moving the interior surface feature from the first position to the second position, the interior surface feature moves away from the dashboard.

12. The method of claim 11, wherein:
a cavity is defined between the interior surface feature and an interior floor of the vehicle when the interior surface feature is in the nominal position, the cavity preventing the airbag from occupying the inflation region when the interior surface feature is in the nominal position; and
a volume of the cavity defined between the interior surface feature and the interior floor of the vehicle reduces as the interior surface feature moves away from the dashboard.

13. The method of claim 11, wherein the interior surface feature comprises a knee bolster panel.

14. A vehicle comprising:
an airbag disposed within an interior cabin of the vehicle, the airbag deployable from a non-deployed state to a deployed state, the airbag configured to occupy an inflation region within the interior cabin of the vehicle while in the deployed state;
an interior surface feature movable between a first position and a second position, wherein the airbag is prevented from occupying the inflation region when the interior surface feature is in the first position;
an actuator coupled to the interior surface feature and configured to move the interior surface feature from the first position to the second position when the airbag deploys from the non-deployed state to the deployed state; and
a controller executing instructions that causes the controller to perform operations comprising:
receiving a collision notification signal indicating that the vehicle has experienced a collision; and
based on receiving the collision notification signal, operating the actuator to move the interior surface feature from the first position to the second position to permit the airbag to occupy the inflation region within the interior cabin of the vehicle.

15. The vehicle of claim 14, wherein:
when the interior surface feature is in the first position, the interior surface feature is in a nominal position that protrudes from a dashboard of the vehicle; and
when the actuator is moving the interior surface feature from the first position to the second position, the interior surface feature moves toward the dashboard.

16. The vehicle of claim 15, wherein:
a surface gap is defined between the interior surface feature and the dashboard of the vehicle when the interior surface feature is in the nominal position that protrudes from the dashboard of the vehicle; and
a length of the surface gap defined between the interior surface feature and the dashboard decreases as the interior surface feature moves toward the dashboard.

17. The vehicle of claim 16, wherein the surface gap prevents the airbag from occupying the inflation region when the interior surface feature is in the nominal position.

18. The vehicle of claim 15, wherein, when the interior surface feature is in the second position, the interior surface feature is in a retracted position coplanar with the dashboard.

19. The vehicle of claim 14, wherein the actuator comprises a linear actuator configured to actuate between an extended position and a retracted position.

20. The vehicle of claim 19, wherein the linear actuator is in one of the extended position or the retracted position when the interior surface feature is in the first position and is in the other one of the extended position or the retracted position when the interior surface feature is in the second position.

21. The vehicle of claim 19, wherein operating the actuator to move the interior surface feature from the first position to the second position comprises operating the linear actuator to actuate from one of the extended position or the retracted position to the other one of the extended position or the retracted position.

22. The vehicle of claim 14, wherein the interior surface feature comprises a display screen of the vehicle.

23. The vehicle of claim 22, wherein the actuator is further operable to adjust an angle of the display screen relative to a dashboard of the vehicle.

24. The vehicle of claim 14, wherein:
when the interior surface feature is in the first position, the interior surface feature is in a nominal position retracted toward a dashboard of the vehicle; and
when the actuator is moving the interior surface feature from the first position to the second position, the interior surface feature moves away from the dashboard.

25. The vehicle of claim 24, wherein:
a cavity is defined between the interior surface feature and an interior floor of the vehicle when the interior surface feature is in the nominal position, the cavity preventing the airbag from occupying the inflation region when the interior surface feature is in the nominal position; and
a volume of the cavity defined between the interior surface feature and the interior floor of the vehicle reduces as the interior surface feature moves away from the dashboard.

26. The vehicle of claim 24, wherein the interior surface feature comprises a knee bolster panel of the vehicle.
